(19) United States
(12) Patent Application Publication
(10) Pub. No.: US 2024/0330521 A1
(43) Pub. Date: Oct. 3, 2024

(54) Clothing Design Apparatus That Applies Pattern Block Structure

(71) Applicant: COCOFA INC., Yeongju-si (KR)

(72) Inventor: Soo Jeong KIM, Yeongju-si (KR)

(21) Appl. No.: 18/682,428

(22) PCT Filed: May 18, 2022
(86) PCT No.: PCT/KR2022/007087

§ 371 Date: Feb. 8, 2024

(30) Foreign Application Priority Data
Aug. 23, 2021 (KR) 10-2021-0111019

(51) Int. Cl. G06F 30/10

(52) U.S. Cl. CPC G06F 30/10

(57) ABSTRACT

The present invention relates to a module-type design teaching aid that performs clothing design and can be used as a teaching aid, and a design apparatus using same, wherein clothing prototypes of various sizes can be easily created by creating pattern blocks that modularize (piece pattern) each of basic parts which are the basis of a clothing pattern of a clothing design of clothing to be designed, and adjusting the distance between unit pattern blocks to match information about a user's specific body type to change dimensions, and the difficulty of designing clothing can be significantly reduced since the designing is carried out while checking changes in dimension with the naked eye.

### CROSS-REFERENCE TO RELATED APPLICATIONS

This application claims the benefit under 35 U.S.C. section 371, of PCT International Application No. PCT/KR2022/007087, filed on May 18, 2022, which claims benefit of priority to Korean Patent Application No. KR10-2021-0111019, filed on Aug. 23, 2021, in the Korean Intellectual Property Office, both of which are hereby incorporated by reference in their entireties.

### TECHNICAL FIELD

The present invention relates to a module-type design teaching aid that performs clothing design and can be used as a teaching aid and a design apparatus using same.

### BACKGROUND ARTS

In general, the development of clothing design (fashion design) has been carried out either by hand by designers or by computer programs. Computer-aided clothing design has been carried out by processing commercial software (Texpro, 3D CLO, etc.) or CAD programs within a computer. The development of typical clothing designs using computers has merely replaced manual labor with programs, and still relies heavily on the subjective competence of the designer to carry out the clothing design and to establish the design concept, theme, etc. required for the clothing design.

In addition, in general, when designing clothing using a computer, it is difficult to predict how the clothing will feel depending on factors such as texture, wearability, etc. because the design is simply conceived and sketched.

### DETAILED DESCRIPTION OF INVENTION

### Technical Subject

The present invention is designed to solve the above problems, and the object of the present invention is to provide a clothing design apparatus that implements a block pattern that modularizes (piece pattern) the basic parts of a clothing pattern that is the basis of a clothing design to design a clothing by parts, and that can easily realize a clothing prototypes of various sizes by adjusting the distance of the unit pattern blocks to conform to the information of the user's specific body shape and transforming the dimensions.

Furthermore, it is another object of the present invention to provide a design apparatus system capable of maximizing the efficiency of design work by enabling a design variation to be implemented by checking the dimension (al) change in real time through a dimension adjustment module capable of checking the dimensional change between mutually adjacent pattern blocks, and, when a sensing device for sensing information according to a distance variation is added, enabling a dimensional variation design process to be selected and checked in real time in connection with a program implemented on a computer.

### Technical Solution

As a means of addressing the above challenges, an exemplary embodiment of the present invention includes a plurality of pattern blocks (100) divided based on an overall outline corresponding to a planar shape of a clothing, as illustrated in FIGS. 1 to 11, wherein the pattern blocks (100) are formed of a plurality of mutually adjacent unit pattern blocks in a first direction (X axis), a second direction (Y axis); a dimension adjusting module (200) disposed in any one of the mutually adjacent unit pattern blocks to indicate a change in distance between adjacent unit pattern blocks, so as to provide a clothing design apparatus applying the pattern block structure.

### Advantageous Effects

According to an exemplary embodiment of the present invention, by implementing/creating a pattern block that modularizes (piece pattern) the basic parts that are the basis of the clothing pattern of the clothing design to be designed, and transforming the dimensions by adjusting the distance of the unit pattern block to meet the information of the user's specific body shape, it is possible to easily implement a clothing prototypes of various sizes, and it has the effect of easing the difficulty of designing the design as it proceeds while checking the transformed dimensions with the naked eye.

Furthermore, the dimension adjusting module, which can check the dimension changes between mutually adjacent pattern blocks, enables the design variation to be implemented by checking the dimension changes in real time, and if a sensing apparatus that senses the information according to the distance variation is added, it is possible to maximize the efficiency of the design work by selecting the dimension variation design process and checking it in real time in conjunction with the program implemented on the computer.

In particular, it is possible to easily respond to dimension changes by dividing each part modularly through the basic size that is the basis of the clothing prototype, and to implement dimension changes that become larger or smaller by part through the change of the position of the piece pattern, so that it is possible to easily draft the prototype of the clothing to be implemented, thereby making the development of clothing design easier and faster, and maximizing the efficiency of design by minimizing the time to produce patterns.

In addition, it can be used as a teaching aid for various clothing design education, making it easier to understand and implement the design of various fashion clothing.

In particular, the present invention employs a design method that implements dimension changes that become larger or smaller in different parts of the body by changing the position of the piece pattern, which makes it possible to easily draft a uniform ready-to-wear clothing made in a certain proportion, and to improve time efficiency, especially in the production of custom-made clothing for peculiar body types that do not fit the ready-to-wear clothing system (body types having peculiar variables such as larger or smaller hips, larger or smaller breasts, changes in length compared to circumference, etc).

### BRIEF DESCRIPTION OF DRAWINGS

FIG. 1 is a flowchart of a process for applying a clothing design apparatus (hereinafter referred to as the present invention) that applies a pattern block structure according to an exemplary embodiment of the present invention.

FIG. 2 is an illustration of a structure of a pattern block (100) that implements the clothing design of the present invention.

FIG. 3 illustrates a process of dimension change according to an unusual body shape using the pattern block according to FIG. 2.

FIG. 4 illustrates a shape of a pattern block of a ready-to-wear top divided into a different number and shape from FIG. 3.

FIG. 5 illustrates an embodiment of a pattern block corresponding to (a) a front part of a trouser, and (b) a back part of a trouser.

FIG. 6 is an example of a unit pattern block of the present invention.

FIG. 7 is an example of a structure of a dimension adjusting module installed in the unit block pattern of FIG. 6.

FIG. 8 illustrates an example of the arrangement of the dimension adjusting module between the unit pattern blocks described above.

FIG. 9 illustrates a structure of a dimension adjusting module according to another exemplary embodiment of the present invention.

FIG. 10 illustrates a system configuration of a clothing design apparatus applying a dimension adjusting module according to another exemplary embodiment of the present invention.

FIG. 11 illustrates an interface screen displayed on a display device via the interface screen illustrated in FIG. 10.

### BEST MODE

The advantages and features of the present invention, and methods of achieving them, will become apparent with reference to the exemplary embodiments described in detail with reference to the accompanying drawings. However, the invention is not limited to the exemplary embodiments described herein and may be embodied in other forms. Rather, the exemplary embodiments described herein are provided so that the disclosure may be thorough and complete and so that the ideas of the invention may be fully conveyed to those skilled in the art.

The terminology used in this application is used to describe certain exemplary embodiments only and is not intended to limit the invention. Expressions in the singular include the plural indicates otherwise. In this unless the context clearly application, the terms “includes” or “has” and the like are intended to designate the presence of the features, numbers, steps, actions, components, parts, or combinations thereof set forth in the specification, and not to preclude the possibility of the presence or addition of one or more other features, numbers, steps, actions, components, parts, or combinations thereof.

Unless otherwise defined, all terms used herein, including technical or scientific terms, shall have the same meaning as commonly understood by one of ordinary skill in the technical field to which the present invention belongs. Such terms, as defined in commonly used dictionaries, shall be construed to have a meaning consistent with their contextual meaning in the relevant art and shall not be construed to have an idealized or unduly formal meaning unless expressly defined in this application.

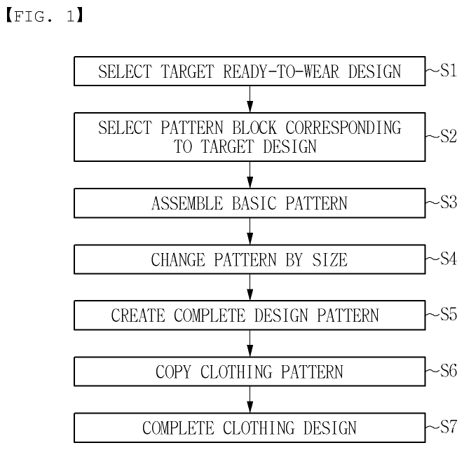

FIG. 1 is a flowchart of a process for applying a clothing design apparatus (hereinafter referred to as the present invention) that applies a pattern block structure according to an exemplary embodiment of the present invention.

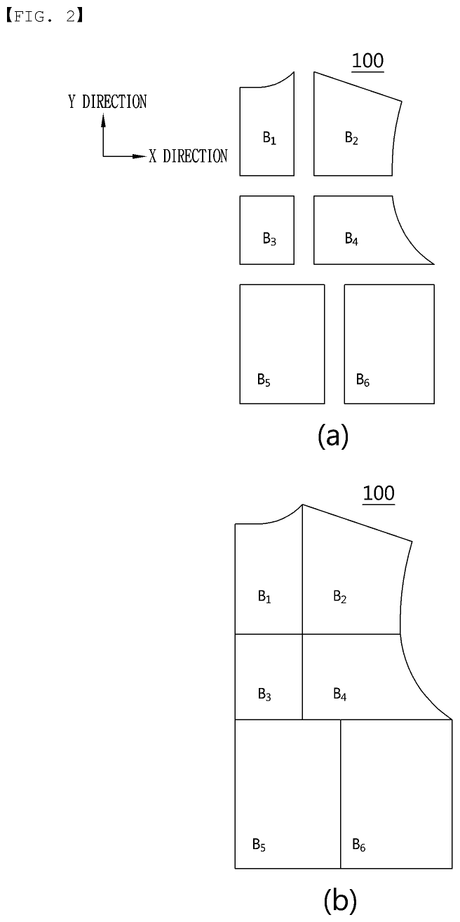

FIG. 2 is an illustration of a structure of a pattern block (100) that implements the clothing design of the present invention.

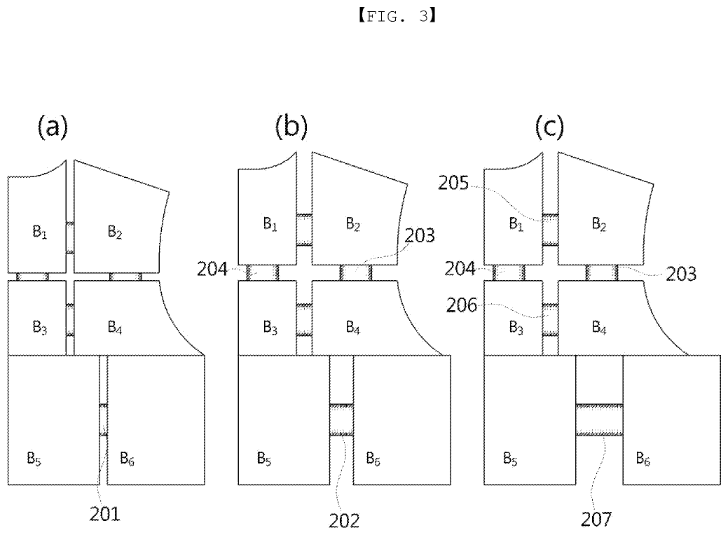

FIG. 3 illustrates a process of dimension change according to an unusual body shape using the pattern block according to FIG. 2.

Referring to FIGS. 1 to 3, the present invention may comprise a plurality of pattern blocks (100) divided on the basis of an overall shape corresponding to the planar shape of the clothing, the pattern blocks (100) being formed from a plurality of blocked unit pattern blocks adjacent to each other in a first direction (x-axis) and a second direction (y-axis). The pattern block (100) may be further configured to include a dimension adjusting module (200) disposed in any one of the mutually adjacent unit pattern blocks to indicate a change in distance between adjacent unit pattern blocks.

In particular, the present invention is aimed at modularly dividing the basic parts that are the basis of a clothing pattern in a clothing design by parts, and arranging and modifying the modularly divided clothing design pattern blocks to facilitate the production of clothing prototypes of various sizes. In particular, the advantages of the present invention are implemented by using a dimension adjustment module (200) that is arranged in any one of the mutually adjacent unit pattern blocks and displays a change in the distance between the adjacent unit pattern blocks, so that a person performing the design can easily visually confirm the dimension change when the dimension change is implemented.

In other words, a clothing design method using the present invention may, when a target ready-to-wear clothing design is selected, select and match pattern blocks that modularize the basic parts which are basis of clothing pattern from the design of the selected clothing, and assemble them into a basic pattern (see FIG. 2).

Then, the basic pattern is changed into a size ‘66’ by increasing the distance between the unit pattern blocks (B5˜B6) of the lower hip part to fit the user's customized body shape by size, as shown in FIG. 3 (a), or B1˜B3 parts are changed into a size ‘77’ to fit the peculiar (specific) body shape, as shown in FIG. 3 (b), to fit the size of a wearer with only a large chest and hip area, by increasing the dimensions of B2˜B4 up and down, and increasing the distance of the unit pattern of B5˜B6 in the hip area, it is possible to realize a finished pattern of a ready-to-wear clothing design tailored to a peculiar type. FIG. 3 (c) illustrates an application example in which the distance of the unit pattern of B5˜B6 is further increased to change the size ‘88’ to fit the specific body type of a wearer with an excessively large hip area.

The clothing pattern may then be copied to the finished pattern and the clothing design may be completed. This process will greatly reduce the accessibility of the professional design field, which traditionally involves complex programs and 3D scanners, by allowing even those with a rudimentary knowledge of clothing design to easily modify/change dimensions to suit the user's specific or peculiar body type.

In particular, for this purpose, the present invention is provided with a dimension adjusting module (200) capable of adjusting the distance between a plurality of blocked unit pattern blocks adjacent to each other in a first direction (X axis) and a second direction (Y axis) after assembling a basic pattern into a plurality of pattern blocks (100) divided on the basis of an overall shape corresponding to the plane shape of ready-to-wear clothing to be designed, so as to adjust the size of a part for peculiar/particular body type, as described above in FIG. 3.

In other words, as shown in FIG. 3 (a), when the basic pattern is modified to a size ‘66’ by increasing the spacing between the unit pattern blocks (B5-B6) of the lower hip area, the distance between the unit pattern blocks can be visually checked by means of the dimension adjusting module (201) embedded in the mutually adjacent unit pattern blocks, and as shown in FIGS. 3 (b) and (c), when the dimensions of B1˜B3, B2-B4 are increased up and down, and the distance of the unit patterns of B5-B6 in the hip area is increased to change the size of the wearer who is only large in the chest area and the hip area to the size of ‘77’ that corresponds to the peculiar type, the dimension adjusting modules (203, 204) in the up and down direction and the dimension adjusting module (207) in the horizontal direction are increased to the left and right to visually check the dimension variation range and implement the design variation. It is possible to implement a finished pattern of a clothing design of ready-to-wear clothing customized to a peculiar (atypical) body shape.

In other words, in the case of a plurality of pattern blocks applied to the present invention, the number and shape of the unit pattern blocks divided according to the shape of the clothing may vary, but they are characterized in that they are optionally provided with dimension adjusting modules (200) in mutually adjacent units.

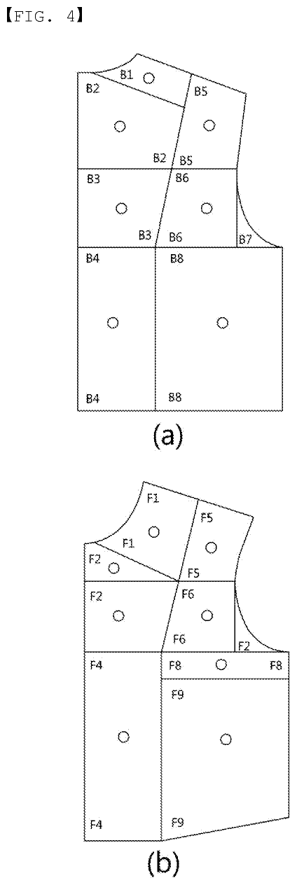

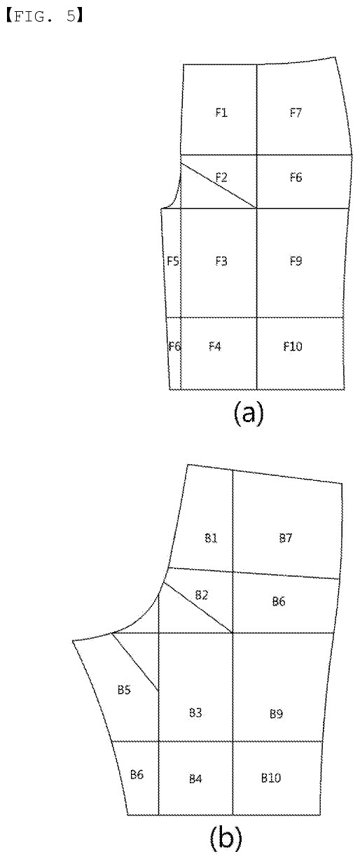

FIG. 4 illustrates a shape of a pattern block of a ready-to-wear top divided into a different number and shape from FIG. 3, and FIG. 5 illustrates an embodiment of (a) a pattern block corresponding to a front portion of a trouser, and (b) a pattern block corresponding to a back portion of a trouser.

In other words, it is within the technical scope of the present invention to apply a module that can be divided into various numbers and shapes of pattern blocks depending on the type of ready-to-wear clothing, and to implement design variations by visually checking the dimension adjustment, or to automatically sense and calculate the dimension distance of the variation.

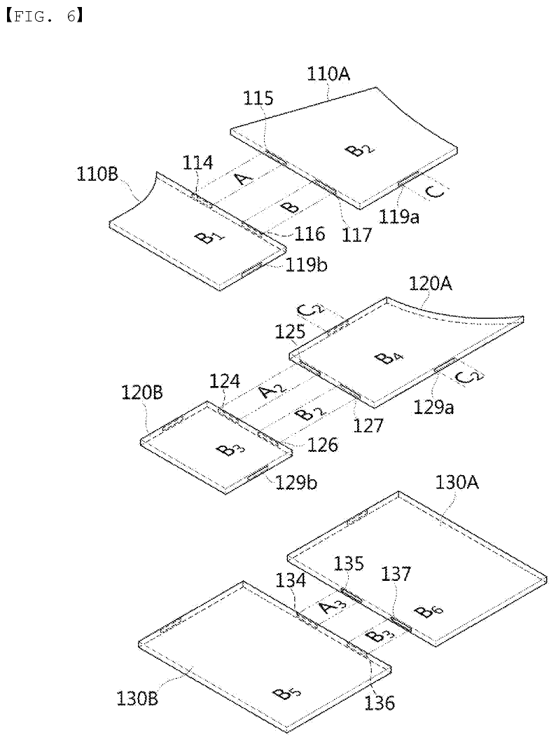

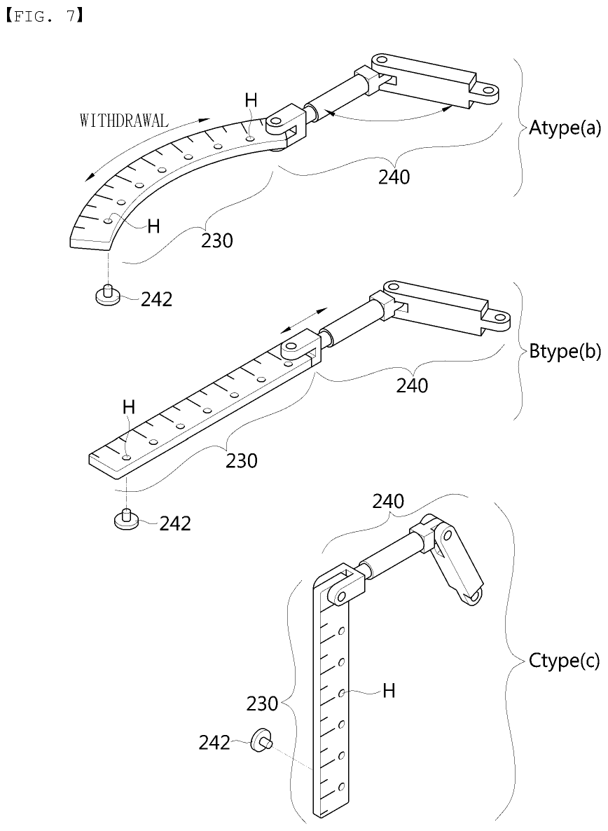

FIG. 6 illustrates an example of a unit pattern block of the present invention, and FIG. 7 illustrates a structure of a dimension adjusting module installed in the unit block pattern of FIG. 6.

Referring to FIGS. 6 and 7, the unit pattern block of the present invention is a structure corresponding to a planar shape of clothing divided into at least two or more pieces, and can be implemented as a three-dimensional structure having a certain thickness.

The unit pattern blocks in directions mutually and adjacently corresponding through left-to-right, and up-to-down ways may be comprised of by including a dimension adjusting module (200) disposed in any one of the adjacent unit pattern blocks to indicate a change in distance between adjacent unit pattern blocks.

The dimension adjusting module (200) may be implemented as a measuring tape-like structure with engraved dimensions (graduations), or as a structure mounted in such a way that it is inserted inside the unit pattern block and can be withdrawn through the withdrawal grooves (114, 115, 116, 117) of the mutually adjacent faces, as shown in FIG. 7.

The dimension adjusting module (200) of the present invention may be formed by including a first module (210) for displaying a change in distance between mutually adjacent unit pattern blocks in a first direction (X-axis direction, horizontal direction) and a second module (220) for displaying a change in distance between mutually adjacent unit pattern blocks in a second direction (Y-axis direction, vertical direction). The dimension adjusting module (200) may be further formed by including, but is not required, a third module {see FIG. 7 (a)} for displaying distance variations due to curvature variations between mutually adjacent unit patterns in the first direction (X-axis direction) or the second direction (Y-axis direction).

The dimension adjusting module (200) may be implemented by a dimension display portion (230) of a bar type having a curvature, as shown in FIG. 7 (a), and a dimension guide portion (240) for guiding the dimension display portion (230) to be withdrawn from inside of the unit pattern block through a withdrawal hole.

Of course, the shape may be implemented as a straight dimension display portion (230) withdrawable in a horizontal direction, as shown in FIG. 7 (b), or as a straight dimension display portion (230) withdrawable in a vertical direction, as shown in FIG. 7 (c).

In either case, the dimension display portion (210) may be withdrawn and inserted through the withdrawal grooves (114 to 117, 124 to 127, 135 to 137) of the respective adjacent and corresponding unit pattern blocks shown in FIG. 6.

Of course, the withdrawal grooves of the mutually adjacent corresponding unit pattern blocks may also be formed on the vertically orientated boundary surfaces (119a, 119b).

Furthermore, in another exemplary embodiment of the present invention, the boundary surfaces of mutually adjacent unit pattern blocks may be provided with magnetic members or attachment patterns to facilitate attachment assembly during basic pattern assembly, while further being formed by including a position fixing member (242) that attaches to a fixing portion (H) on the surface of the dimension display portion (230) to fix the corresponding block in a deformed dimensional position after the withdrawal and retraction operation of the dimension display portion (230), as shown in FIG. 7.

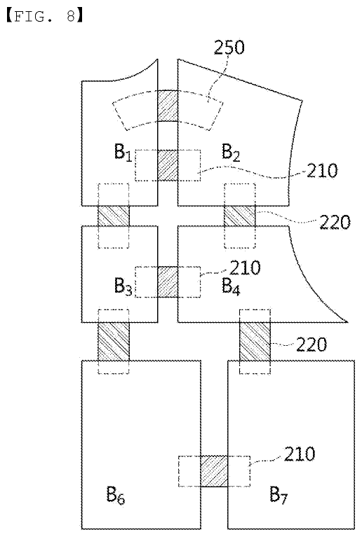

FIG. 8 illustrates an example of the arrangement of the dimension adjusting module between the unit pattern blocks described above, with a first module (210) displaying a change in distance between mutually adjacent unit pattern blocks in the first direction (X-axis direction), a second module (220) displaying a change in distance between mutually adjacent unit pattern blocks in the second direction (Y-axis direction), and a third module (250) that displays a change in distance due to a change in curvature between mutually adjacent unit patterns in the first direction (X-axis direction) or the second direction (Y-axis direction). In this case, the first module, the second module, and the third module may be arranged by selectively applying at least one of the first, second and third modules.

According to the thus-mentioned present invention, by implementing a pattern block that modulates the basic parts that are the basis of the clothing pattern of the clothing design to be designed by each part, and transforming the dimensions by adjusting the distance of the unit pattern blocks to conform to the information of the user's peculiar (specific) body shape, it is possible to easily implement a clothing prototype of various sizes, and the advantages of easing the difficulty of designing the design are implemented while proceeding by checking the transformed dimensions with the naked eye.

Hereinafter, another embodiment of the present invention will be described in which a real-time online confirmation may be performed in conjunction with the movement of the above-described pattern blocks by means of a programs executed on a computer in conjunction with the clothing design apparatus of the present invention.

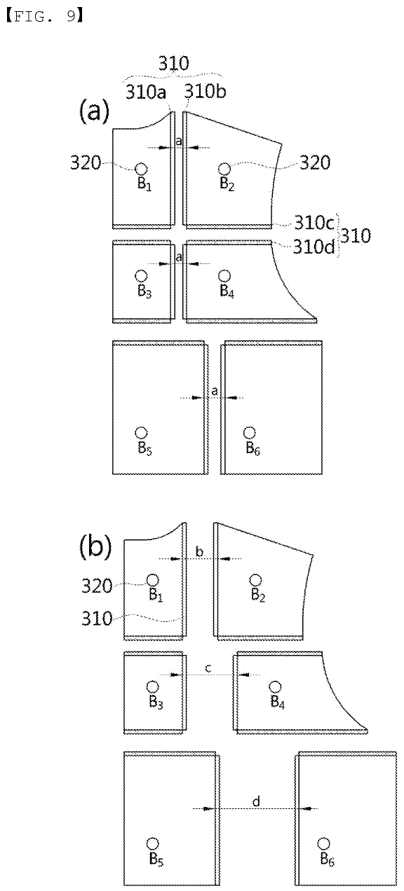

FIG. 9 illustrates a structure of a dimension adjusting module according to another embodiment of the present invention, wherein the dimension adjusting module may be formed by implementing a pair of distance detection sensor modules (310) disposed on adjacent side parts of a unit pattern block and interlocked with a corresponding object.

The distance detection sensor module (310) senses the change in distance between adjacent unit pattern blocks by installing sensors such as light sensors, ultrasonic sensors, laser sensors, etc. and senses the detected distance change in real time and transmits the same to a terminal device or display device that monitors the change in dimensions.

For this purpose, the present invention may include a pair of distance detection sensor modules (310) disposed on adjacent side parts of the unit pattern blocks and interlocked with corresponding objects, and an identifier (320) including identification code information identifying objects of the unit pattern blocks, and the information about the identifier can be transmitted to a design server (10) through the wireless communication portion (330) to interlock with the design pattern blocks selected by the design server (10).

In other words, in order to know which unit pattern block's distance has changed, an identifier (320) an comprising identification chip is mounted on the unit pattern block, and when the unit pattern block corresponding to the identifier moves, the information of the distance change is transmitted to the design server (10).

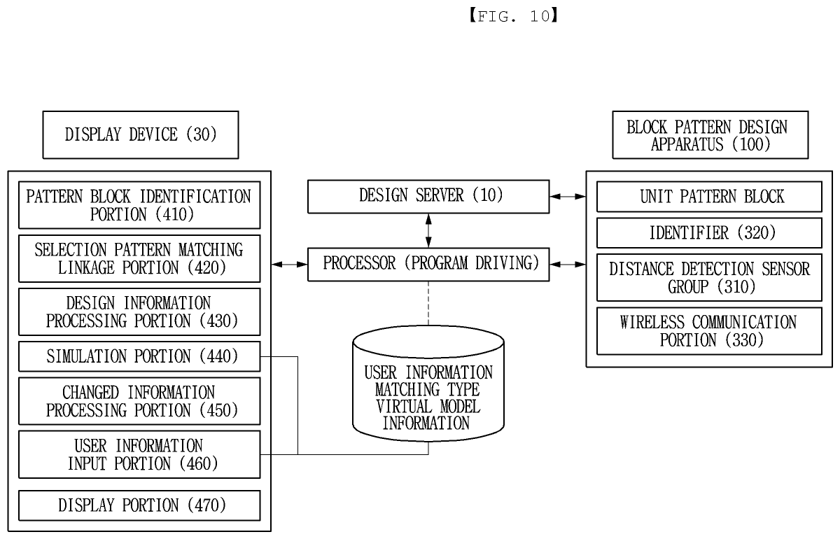

The information thus changed may be confirmed in real time through a user terminal device connected to the design server, and for this connection, as shown in FIG. 10, the design server (10) is provided with a configuration for sensing changes in the distance information between the above-described unit pattern blocks and processing the information transmitted.

In one exemplary embodiment, the design server (10) may include a processor (11) and a display device (30) comprising a memory associated with the processor (11), and may further include a display device (30), based on the information provided through the wireless communication portion (330), having a program that receives input of a unit pattern block and dimensional deformation information of the unit pattern block and interfaces with the current status of the unit pattern block via an interface.

In particular, in this case, the display device (30) may be formed by including a pattern block identification portion (410) that identifies a type of pattern through the identifier (320) of the unit pattern block and loads and displays image information of the corresponding unit pattern block, a selection pattern matching linkage portion (420) that receives dimensional variation information of the unit pattern block displayed from the distance detection sensor group (330) and links and displays image information of the unit pattern block displayed, a design information processing portion (430) that stores and displays a design pattern determined upon completion of the design process, a simulation portion (440) that simulates and displays the determined design pattern provided by the design information processing portion (430) on a graphical model, and a changed information processing portion (450) that receives input information of deformation and dimensional changes from the information displayed by the simulation portion (440) and links the same to a simulated screen.

In addition, the display device (30) may be formed by further including a user information input portion (460) that receives and inputs information on areas requiring dimensional changes of a wearer with a peculiar or unusual body shape, and checks if matched against a “finished design pattern” with the dimensional changes completed, and a display portion (170) that processes the information on the overall display screen.

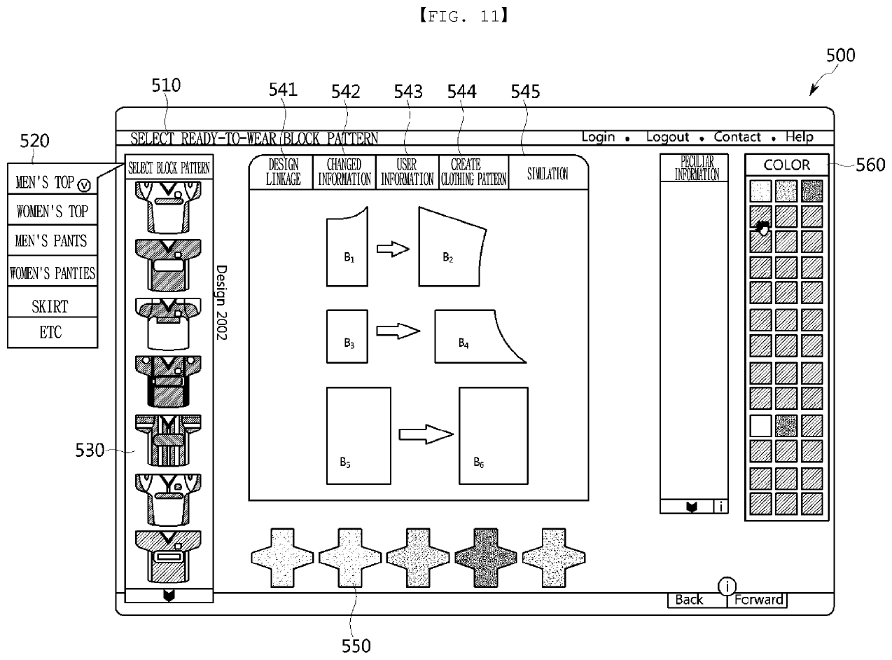

This functional configuration may be displayed on the display screen via the interface screen shown in FIG. 11, which allows the user to see the movement of the virtual pattern blocks in conjunction with the movement of the offline pattern blocks, and to interact directly with the design.

According to the operation of the above configuration, when the user selects (520) a pattern block item of a menswear top from a pattern block of a clothing to be designed through the display, if the target ready-to-wear design is a menswear top, the same shape as the pattern block prepared offline appears on the display.

Then, when a design linkage (540) is clicked, the offline pattern block and the processor of the display device are linked through the controller, and the basic pattern structure for assembling the pattern block is set to an initial screen.

Then, as shown in FIG. 11, if the dimension of each unit pattern block changes, the distance detection sensor detects the same, identifies the distance between the unit pattern blocks through the identifier, and transmits the same to the processor through the wireless communication portion.

When the dimension change between the unit pattern blocks is completed through the real-time interlocking information, the finished design pattern is determined by storing the same, and then when the ‘Create Clothing Pattern’ function is clicked, the clothing pattern for the finished design pattern is automatically imaged and derived.

Then, when the “Simulation” function is clicked, the complete design pattern is simulated and displayed on the graphical model. Through the above process, it is possible to simulate whether it is suitable for a graphical human body model having an unusual/peculiar body shape, and if it is necessary to correct the dimensions thereof, it is possible to receive input information of deformation and dimension correction from the information displayed in the simulation portion (440), and to interlock with the simulated screen.

The functions of pattern selection portion (550), which selects the pattern of the clothing design through the complete clothing pattern, and the color selection portion (560), make it easier to create a detailed shape of the complete clothing design.

The results of the automated design programs according to the present invention can be applied in conjunction with an automated system that can be used in conjunction with a clothing production program to produce samples of the designed product immediately.

Furthermore, the automated design programs according to the present invention can be used as a teaching program for trainees undergoing design education, enabling them to easily apply and master complex design processes, thereby achieving excellent educational results.

As shown above, the technical ideas of the present invention have been described in detail in a preferred embodiment, but the above preferred embodiment is intended to be illustrative and not limiting. As such, one of ordinary skill in the art will appreciate that various embodiments are possible by combining embodiments of the present invention within the scope of the technical ideas of the present invention.

1. A clothing design apparatus applying the pattern block structure for performing a clothing design, comprising: a plurality of pattern blocks (100) divided on the basis of an overall shape corresponding to the planar shape of the clothing, wherein the pattern blocks (100) are formed from a plurality of blocked unit pattern blocks adjacent to each other in a first direction (x-axis) and a second direction (y-axis), and the clothing design apparatus further includes a dimension adjusting module (200) disposed in any one of the mutually adjacent unit pattern blocks to indicate a change in distance between adjacent unit pattern blocks.

2. The clothing design apparatus of claim 1, wherein the dimension adjusting module (200) includes: a first module (210) indicating a change in distance between mutually adjacent unit pattern blocks in a first direction (x-axis direction); and a second module (220) indicating a change in a distance between mutually adjacent unit pattern blocks in a second direction (y-axis direction).

3. The clothing design apparatus of claim 2, wherein the dimension adjusting module (200) includes a dimension display portion (230) that is inserted into the interior of the unit pattern blocks that are adjacent to each other, and a dimension guide portion (240) for guiding the dimension display portion (230) to be withdrawn from the interior of the unit pattern block through the withdrawal hole (230).

4. The clothing design apparatus of claim 3, wherein the dimension adjusting module (200) further includes a position fixing member (242) for fixing a position by attaching to a surface of the dimension display portion (230) after withdrawal and retraction of the dimension display portion (230).

5. The clothing design apparatus of claim 4, wherein the dimension adjusting module (200) further includes a third module (250) for displaying a distance change due to a change in curvature between mutually adjacent unit patterns in the first direction (x-axis direction) or the second direction (y-axis direction).

6. The clothing design apparatus of any one claim 1 to claim 5, wherein the dimension adjusting module (200) includes a pair of distance detection sensor modules (310) disposed on adjacent side portions of the unit pattern blocks and interlocked to corresponding objects, and an identifier (320) comprising identification code information identifying the objects of the unit pattern blocks, and wherein the information about the identifier is transmitted to a design server (10) via a wireless communication portion (330) to be associated with a design pattern block selected by the design server (10).

7. The clothing design apparatus of claim 6, wherein the designed server 10 includes a processor (11) and a memory connected to the processor (11), and further includes a display device (30) having a program to input a unit pattern block and a dimensional change (deformation) information of the unit pattern block based on the information provided through the wireless communication portion (330), and to link the current status of the unit pattern block through an interface.

8. The clothing design apparatus of claim 7, wherein the display device (30) includes:
a pattern block identification portion (410) that identifies a type of pattern through the identifier (320) of the unit pattern block and loads and displays image information of the corresponding unit pattern block;
a selection pattern matching linkage portion (420) that receives dimensional variation information of the unit pattern block displayed from the distance detection sensor group (330) and links and displays image information of the unit pattern block displayed;
a design information processing portion (430) that stores and displays a design pattern determined upon completion of the design process;
a simulation portion (440) that simulates and displays the determined design pattern provided by the design information processing portion (430) on a graphical model; and
a changed information processing portion (450) that receives input information of deformation and dimensional changes from the information displayed by the simulation portion (440) and links the same to a simulated screen.
